(19) United States
(12) Patent Application Publication
(10) Pub. No.: US 2004/0177911 A1
(43) Pub. Date: Sep. 16, 2004

(54) Method for producing a thermoplastically deformadable, fibre-reinforced semi-finished product

(76) Inventor: Harri Dittmar, Battenberg (DE)

Correspondence Address: FOLEY AND LARDNER, SUITE 500, 3000 K STREET NW, WASHINGTON, DC, 20007, US

(21) Appl. No.: 10/470,969

(22) PCT Filed: Jan. 26, 2002
(86) PCT No.: PCT/EP02/00835

(30) Foreign Application Priority Data
Feb. 8, 2001 (DE) 101 05 813.6

(51) Int. Cl. B32B 31/00

(52) U.S. Cl. 156/62.2; 156/148

(57) ABSTRACT

The invention relates to a continuous method for producing a thermoplastically deformable, thin semi-finished product consisting of a thermoplastic and long reinforcement fibres. The method comprises the following steps: A. the thermoplastic fibres and reinforcement fibres are mixed in their dry state to form a mixed nonwoven, B. the mixed nonwoven is bonded by needling, C. the bonded mixed nonwoven is heated and D. pressed to form a semi-finished product on a calender or in a smoothing device.

The invention relates to a method for producing a thermoplastically deformable fiber-reinforced semifinished product from a mixed non-woven in which thermoplastic fibers and reinforcing fibers are present.

Thermoplastically deformable semifinished products which comprise reinforcing fibers, in particular glass fibers, are increasingly used for producing moldings, in particular for motor vehicle parts. These “plastic panels” have high toughness and strength. The semifinished GMT products are produced on a large industrial scale by uniting continuous glass mats and webs of thermoplastic melt on a twin-belt press. However, this mode of operation is energy-intensive, because the high-viscosity melt has to be pressed into the mat. Fiber contents of more than 50% by weight are rarely achievable by this method. Since the glass mats are generally composed of fiber bundles, the saturation process is never entirely complete and uniform, the result being the ocurrence of regions of microscopic inhomogeneity, leading to high standard deviations of mechanical properties.

Another process used in industry is similar to paper-making. Thermoplastic fibers and reinforcing fibers are mixed with one another in the form of an aqueous slurry, the slurry is squeezed, and the resultant mixed non-woven is dried and hot-pressed. This involves handling large amounts of water, and the purification of waste water contaminated with auxiliaries. In addition, only relatively short fibers whose maximum length is 2.5 cm can be used here, the consequence being inadequate mechanical properties.

DE-A 36 14 533 describes a process for producing moldings from thermoplastics which comprise an inserted reinforcement. This is similar to textile fiber technology in that a mixed non-woven composed of thermoplastic fibers and reinforcing fibers is produced by the carding or airlay process and consolidated, for example, by needling. Cut-to-size pieces from this mixed non-woven are heated and are directly, with no prior consolidation, pressed to give three-dimensional moldings. However, complete and thorough saturation is rarely achieved here, especially in the case of components of complicated shape, and the mechanical properties of the moldings are therefore unsatisfactory.

U.S. Pat. No. 4,948,661 describes the production of a consolidated semifinished product whose thickness is from 1.25 to 2.5 mm. First, a dry process produces a mixed non-woven from thermoplastic fibers and reinforcing fibers. However, this mixed non-woven is not needled, but is folded together in the manner of corrugations, and is consolidated directly through hot-pressing to give the semifinished product. Because there is no consolidation of the mixed non-woven, the only practical problem-free consolidation method is batchwise consolidation. Although mention is also made of continuous consolidation on a twin-belt press, this would be associated with the disadvantages described above—if indeed it is feasible in practice. Since U.S. Pat. No. 4,948,661 is especially orientated toward a smooth, glossy surface, fiber breakage has to be avoided, and this would be the inevitable consequence of needling. A further disadvantage of semifinished products made from mixed non-wovens which have not been needled is that moldings produced from these have no reinforcement in the z-direction, i.e. perpendicularly to the principal surface.

Finally, EP-A 555 345 describes an air-permeable fiber structure made from a mixed non-woven produced by a wet or dry method and composed of thermoplastic fibers and reinforcing fibers. This mixed non-woven, which has not been needled, is partially consolidated by careful incipient melting of the thermoplastic fibers, by bonding these to the reinforcing fibers at the intersections. Continuous production of the fiber structure is not described. Another disadvantage of the process is that the non-wetted reinforcing fibers can corrode during storage, and here again it is difficult to obtain complete and thorough saturation during the production of moldings.

An object of the present invention was then to develop a continuous process for producing a relatively thin semifinished product from a thermoplastic and relatively long reinforcing fibers, the semifinished product being capable of forming to give finished parts which, in all directions, have mechanical properties which are excellent and highly reproducible. The inventive method achieves this object. This encompasses the following steps of the process:

A) dry-mixing thermoplastic fibers and individual, non-bonded synthetic reinforcing fibers with one another, using the carding process or the airlay process. Thermoplastics which may be used are any of the spinnable thermoplastics, e.g. polyolefins, such as polyethylene and polypropylene, polyamides, linear polyesters, thermoplastic polyurethanes, polycarbonate, polyacetals, and also corresponding copolymers and mixture, and moreover high-temperature-resistant polymers, such as polyarylates, polysulfones, polyimides and polyether ketones. Polypropylene is particularly preferred. The corresponding fibers may be produced by spinning the thermoplastic melts or spinning solutions of the thermoplastics. The average length of the thermoplastic fibers is generally from 10 to 200 mm.

Preferred reinforcing fibres are glass fibers, and besides these use may also in principle be made of carbon fibers and aramid fibers. The average length of the reinforcing fibers is generally from 30 to 300 mm, preferably more than 50 mm. In order that they have good miscibility with the thermo-plastic fibers, they have to be present in the form of individual, non-bonded fibers, and this means that they must not have been bonded by polymeric binders.

The thermoplastic fibers and reinforcing fibers are dry-mixed with one another in a ratio by weight of from 10:90 to 80:20, preferably 25:75 to 55:45, by the carding process or airlay process known from textile technology. This gives a mixed non-woven in the form of a continuous web.

B. The resultant mixed non-woven is consolidated by needling. This may take place on conventional needlelooms, using felting needles. The needling firstly causes some breakage of the reinforcing fibers, thus reducing the average fiber length; secondly, individual fibers are drawn through the non-woven, therefore becoming oriented perpendicularly to the principal surface, with capability to exert reinforcing action in this direction in the finished part. In addition, these perpendicularly oriented fibers cause the semifinished product to expand in the z direction on heating. This “loft” can be utilized to produce lightweight components via partial consolidation. Finally, the inventive needling consolidates the mixed non-woven, which can therefore be handled without difficulty in the subsequent steps of the process.

In one specific embodiment of the invention, the needled mixed non-woven is stretched in one direction. As a result of this, the reinforcing fibers also have this orientation in the finished part, thus bringing about a particularly high level of mechanical properties in this direction.

C) The consolidated mixed non-woven is heated in a convection oven or by IR radiation to temperatures above the softening point of the thermoplastic. The preferred extent to which the temperature should be above the softening point is from 20 to 60° C.; in the case of polypropylene fibers, the temperature is preferably from 180 to 220° C., in particular from 190 to 210° C.

D) The heated mixed non-woven is then immediately pressed on a calender or in a polishing stack. Preferred pressures applied here are from 1 to 10 bar. According to the invention, the thickness of the resultant semifinished sheet is from 0.2 to 3.0 mm, preferably from 1.2 to 2.0 mm. The thickness may also be less than 1.2 mm for specific applications. The average length of the reinforcing fibers in the semifinished product is from 20 to 200 mm, and the fibers preferably have an average length of more than 50 mm.

E) In one preferred embodiment of the invention, during the pressing process, functional layers are brought in contact with one or both sides of the heated mixed non-woven and concomitantly pressed. These may be decorative layers, thin fiber non-wovens, thermoplastic films or webs of fabric. It is also possible, in principle, to delay application of the functional layers until production of the molding has begun.

The semifinished product produced according to the invention may be rolled up and stored. It may then be thermoplastically deformed to give three-dimensional finished parts. For this, appropriate cut-to-size pieces are heated to temperatures above the softening point of the thermoplastic, and pressed in conventional two-part molds, or deformed by thermoforming. The finished parts may be used in the transport sector as interior parts for automobiles, for railway equipment, and for aircraft, or else as bodywork parts, as large-surface-area panels, or else as furniture parts.

1. A continuous process for producing a thermoplastically deformable semifinished product whose thickness is from 0.2 to 3.0 mm, composed of from 10 to 80% by weight of a thermoplastic and from 90 to 20% by weight of reinforcing fibers, the steps of the process being as follows:
A) dry-mixing thermoplastic fibers and individual, non-bonded synthetic reinforcing fibers whose length is from 20 to 80 mm with one another by the airlay process or the carding process to give a continuous web,
b) consolidating the resultant mixed non-woven by needling,
c) heating the consolidated mixed non-woven in the convection oven or by infra-red radiation to temperatures above the softening point of the thermoplastic,
d) then pressing the heated mixed non-woven on a polishing stack or calender at low pressures of from 1 to 10 bar to give the semifinished product,
e) where appropriate, simultaneously or subsequently, using pressure to apply functional layers to the semifinished product.

2. The process as claimed in claim 1, characterized in that the thickness of the semifinished product is from 1.2 to 2.0 mm.

3. The process as claimed in claim 1, characterized in that the thickness of the semifinished product is less than 1.2 mm.

4. The process as claimed in claim 1, characterized in that the average length of the reinforcing fibers is more than 50 mm.

5. The process as claimed in claim 1, characterized in that the thermoplastic is polypropylene.

6. The process as claimed in claim 1, characterized in that the reinforcing fibers are glass fibers.

7. The process as claimed in claim 1, characterized in that the needled mixed non-woven is stretched in one direction.

8. The use of the semifinished product produced as claimed in claim 1 for producing three-dimensional finished parts by thermoforming in a press.

9. The use of the semifinished product produced as claimed in claim 7 for producing three-dimensional finished parts which have a particularly high level of mechanical properties in one preferred direction.
